(19) United States
(12) Patent Application Publication
(10) Pub. No.: US 2005/0221935 A1
(43) Pub. Date: Oct. 6, 2005

(54) Engine belt drive system

(76) Inventors: Keith Hall, Maidenhead (GB); Nathan Roulson, Halstead (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/092,267

(22) Filed: Mar. 29, 2005

(30) Foreign Application Priority Data
Mar. 30, 2004 (GB) 0407089.2

(51) Int. Cl. F16H 7/12

(52) U.S. Cl. 474/135; 474/133

(57) ABSTRACT

A method of fitting a drive belt (15) to a drive belt system and a pulley assembly for performing the method, the belt system including a drive pulley (11), and at least one driven pulley (12, 13) preferably including an idler pulley (14) with the belt run around said pulleys being substantially planar, wherein in said method one pulley (14) is part of a pivotable pulley assembly (21), the pivotable pulley is tilted relative to the plane of the belt run, the belt (15) is fitted around the pulleys (11, 12, 13, 14) and the tilted pulley assembly (21) is then moved to lie substantially in the plane of the belt run to tension the belt.

### FIELD OF THE INVENTION

This invention relates to a belt drive system of the type which are utilised on internal combustion engines for driving accessory equipment, and in particular to belt drive systems which are used in relation to motor vehicle engines.

### BACKGROUND OF THE INVENTION

Some belt drive systems for transferring rotary drive from an engine crankshaft pulley to one or more accessory equipment pulleys often include an idler pulley within the belt run. More recent developments include the use of elastic drive belts formed from a rubber and textile cord composite. Belt drive systems which use elastic drive belts often have no tensioner so that special belt fitting tools are required when fitting a drive belt to the system. These tools are expensive, need to be supplied with each re-placement belt, and generally lack robustness.

Other systems may utilise an idler pulley assembly in which the pulley position is adjustable within the plane of the belt allowing the belt to be placed over the pulley when the pulley is in one location and the pulley is then moved typically on a screw adjuster until the belt is no longer slack.

The present invention provides an alternative method of fitting an elastic belt to a drive belt system and pulley assembly that facilitates the fitting of such belts.

### SUMMARY OF INVENTION

A first aspect of the present invention provides a method of fitting a drive belt to a drive belt system including a drive pulley and at least one driven pulley with the belt run around the pulleys being substantially planar and wherein the or one of the driven pulleys is pivotable relative to the plane of the belt run, the method comprising the steps of tilting the pivotable pulley relative to the plane of the belt run to enable location of the drive belt on the pulleys without stretching the belt, fitting the belt around the pulleys, and moving the tilted pulley to lie substantially in the plane of the belt run to tension the belt.

The pivotable pulley may be tilted at up to 90° of arc relative to the plane of the belt run, more typically up to 45° of arc.

The pivotable pulley may be mounted for rotation on a support, and the support may be pivotally mounted at a location offset behind the rotational plane of the pulley. The support may include an accessory body or housing e.g. a steering pump body.

When used for a belt system on an internal combustion engine, the supports may be mounted on the engine, or an engine component, by a plurality of bolts one of which may act as the pivot for the support.

The pivotable pulley is preferably an idler pulley.

The pivotable pulley may be moved by application of a lever to apply a tensioning load to the belt as the pivotable pulley is moved into the plane of the belt. During the application of the tensioning load a detent may hold the support in its correct location to facilitate the fitting of the other bolts.

According to a second aspect of the invention there is provided an internal combustion engine having a belt drive system including a drive pulley and an accessory system driven pulley assembly, wherein the driven pulley assembly comprises a support having a pulley mounted thereon for rotation about a first axis and a pivot point for pivoting around a second axis normal to the first axis, with a drive belt passing around the pulleys in a substantially planar belt run, the support being pivotable about the second axis relative to the engine allowing the driven pulley to be tilted relative to the plane of the belt run to enable the drive belt to be located on the pulley without stretching the belt.

The pivot point may be provided by a through bore in the support, that in use co-operates with a bolt to form a pivot. A plurality of further bolt holes may be formed in the support substantially parallel to the pivot axis.

The support may have an upper face located above the pulley and which has a cavity therein in use for receiving a lever for tensioning a belt passing around the pulley. The support may also be provided with an upper side face having a lug thereon which in use engages a detent to locate the support.

The pulley assembly is preferably an idler pulley assembly.

For a driven pulley located above the drive pulley, the support may be pivoted to the engine block at a point below the axis of rotation of the idler pulley and preferably offset behind the rotational plane of the pulley. The support may be mounted on the engine block by a plurality of bolts, one of which acts as the pivot for the support.

The support has limited free play around the pivot bolt allowing the support to be inclined relative to the engine allowing a lug on the support to pass over a detent on the engine. The lug in use engages the detent to hold the support in its correct location to facilitate clamping of the support by means of the bolts.

### DESCRIPTION OF THE DRAWINGS

The invention will be described by way of Example and with reference to the accompanying drawings in which:

FIG. 1 is a front view of belt drive system,

FIG. 2 a side view of the front of an internal combustion engine including an idler pulley assembly according to the present invention,

FIG. 3 is an isometric view of a pulley assembly according to the present invention,

FIG. 4 is a vertical section through the pulley assembly shown in FIG. 3.,

FIG. 5 is a side view of the pulley assembly support shown in FIG. 3 and

FIG. 6 is a front view of the support shown in FIG. 5.

### DETAILED DESCRIPTION OF THE PREFERRED EMBODIMENTS

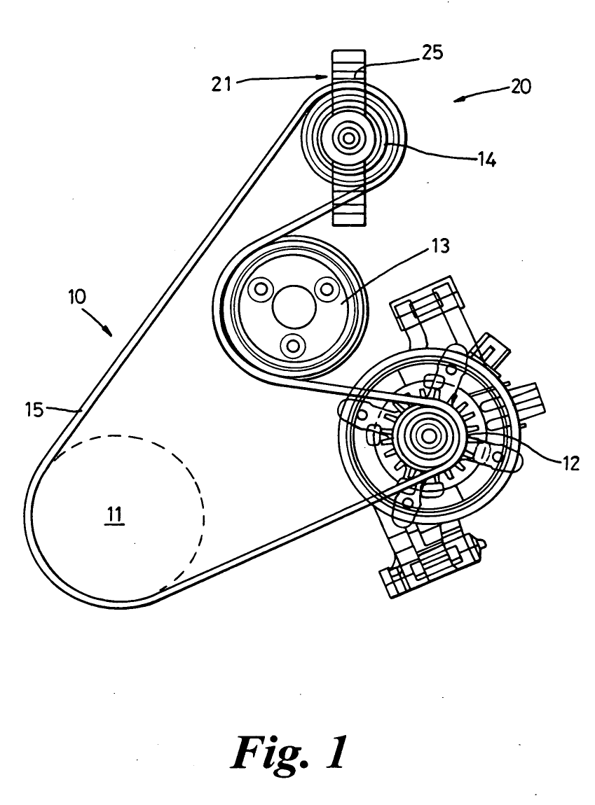

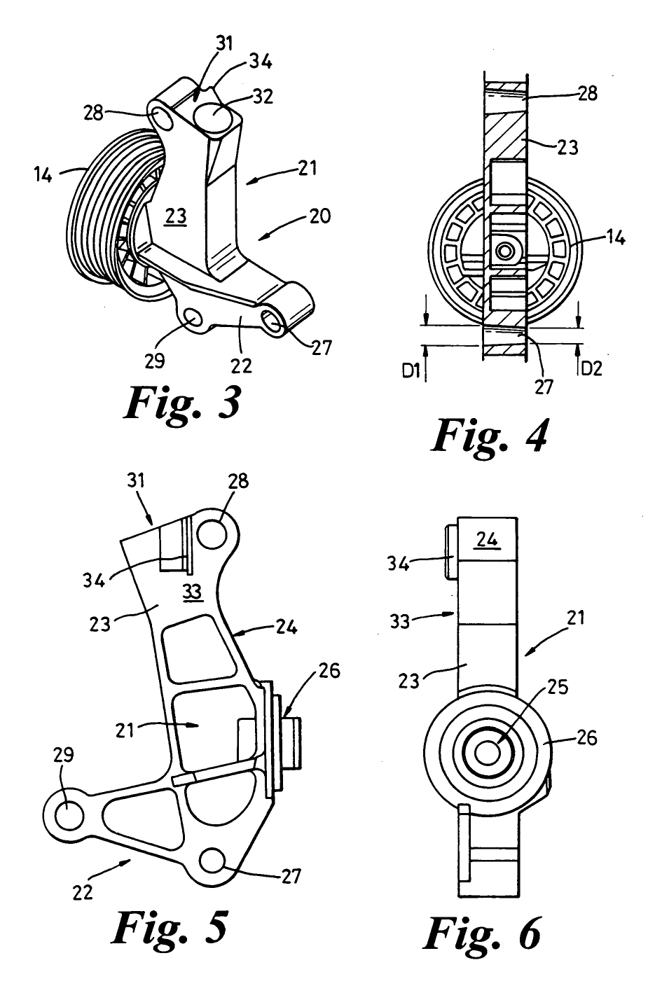

With reference to FIG. 1 there is shown a drive belt system 10 comprising a drive pulley 11, shown in dotted outline, two engine accessory system driven pulleys 12 &13, an idler pulley 14 and a belt 15. The drive pulley 11 is typically a crankshaft pulley and examples of typical accessory system pulleys 12 & 13 are an alternator pulley, a water pump pulley, air conditioning compressor pulley, and steering pump pulley. The belt 15 is an elastic belt typically having a plurality of parallel V shaped teeth extending around the inner surface of the belt and which in use engage like V shaped grooves 15 on the pulleys (see FIG. 3).

With reference now to FIGS. 3 to 6, there is shown an idler pulley assembly 20 in which the idler pulley 14 is mounted for rotation on the front end of a support 21. The support 21 is generally planar being “L” shaped with a foot 22 and a generally upright leg 23. The front edge face 24 of the leg 23 at mid-height has a circular boss 26 thereon on which the idler pulley 14 is mounted. The boss 26 having a central hole 25 that accommodates a pin, screw, or bolt etc. about which the idler roller pulley is free to rotate.

The support 21 has a pivot point 27 located at the bottom of the leg 23 in the form of a circular hole by which the support is pivoted to the side of an engine block, or head by a bolt passing through the hole 27. The hole 27 tapers from a wider diameter D1 at its outer end away from the engine to a smaller diameter D2 at its inner end adjacent the engine. This provides some play around a loosened bolt to enable the support 21 to be inclined relative to the engine. The support is provided with other bolt holes 28, 29 at the free ends of the leg and foot respectively for securing the assembly to a mounting surface on the side of an engine.

The upper face 31 of the leg 23 has a cavity 32 therein for insertion of a lever for tensioning the belt 15 as will be described later.

The inner side 33 of the leg 23, that is nearest the engine, has a V shaped lug 34 thereon which in use co-operates with a detent (not shown) on the engine to locate the idler assembly during tensioning of the belt.

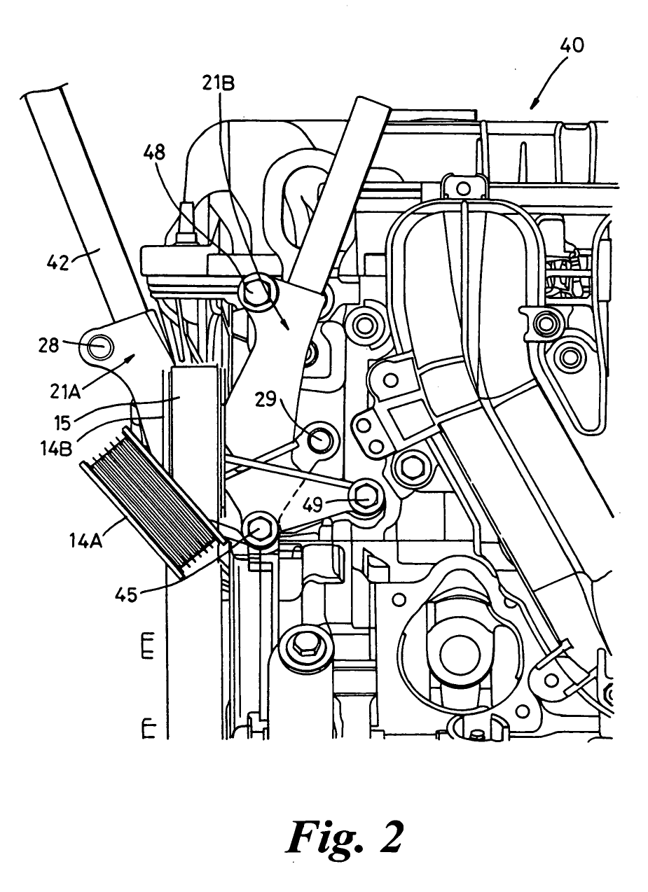

With reference now to FIG. 2, the idler pulley assembly 21 is shown mounted to the side of an engine 40. The assembly 21 is shown in two conditions, i) as 21A with the pulley wheel 14 tilted forward to receive a belt 15 and with a lever 42 shown in situ in the cavity 32 and ii) as 21B in the tensioned condition with all bolts holding the support to the engine and the lever 42 still in location.

In use, the idler assembly 21 is pivoted to the engine by a bolt 45 passing through the pivot hole 27 and which is slackened off to allow the support to both rotate and rock relative to the bolt 45 and engine. The pivot point 27 is located at a point below the axis of rotation of the pulley wheel 14 and is off-set behind the plane of the wheel. The support 21 will typically be capable of rocking up to 5° inclination relative to the engine surface to which it is bolted. There should be sufficient play around the bolt 45 to allow the lug 34 to clear its detent on the engine. The idler pulley is tilted forward around the pivot point 27 to enable the drive belt 15 to be fitted around the pulleys 11, 12, 13, 14 without stretching the belt. The idler pulley 14 will typically be tilted at an angle of up to 90° of arc and more typically 40°-45° of arc.

The pulley assembly 21 is then pulled upright by the lever 42 such that the idler pulley 14 lies substantially in the plane of the belt run to tension the belt 15. The play around the bolt 45 allows the lug 34 to pass over and then locate behind a detent, e.g. a machined shoulder on the engine. The location of the lug behind the detent (not shown) ensures that a correct tension load is applied to the belt and substantially aligns the bolt holes 28, 29 in the support 21 with the fixing holes in the engine (not shown). Bolt 45 is then fully tightened, allowing bolts 48, 49 to be inserted whilst the belt is under tension.

1. A method of fitting a drive belt to a drive belt system including at least two pulleys with a belt run around the pulleys being substantially planar and wherein at least one of the pulleys is pivotable relative to the plane of the belt run, the method comprising the steps of:
(i) tilting the at least one pivotable pulley relative to the plane of the belt run to enable location of the drive belt on the pulleys without stretching the belt;
(ii) fitting the drive belt around the at least two pulleys; and
(iii) moving the at least one pivotable pulley to lie substantially in the plane of the belt run to tension the drive belt.

2. The method as claimed in claim 1, wherein the at least one pivotable pulley is tilted at up to 90° of arc relative to the plane of the belt run.

3. The method as claimed in claim 1, wherein the at least one pivotable pulley is mounted for rotation on a support at a pivot point offset behind a rotational plane of the at least one pivotable pulley.

4. The method as claimed in claim 3, wherein the support is mounted on an internal combustion engine by a plurality of bolts, and one of the plurality of bolts acts as the pivot point.

5. The method as claimed in claim 4, wherein the support is moved by application of a lever to the support to apply a tensioning load to the belt as the tilted pulley is moved into the plane of the belt run.

6. The method as claimed in claim 5, wherein during the application of the tensioning load a detent locates the support in its correct location applying a correct tension load and to facilitate the fitting of the other bolts.

7. A method as claimed in claim 1, wherein the at least one pivotable pulley is an idler pulley.

8. An internal combustion engine having a belt drive system including a drive pulley and adriven pulley assembly, wherein the driven pulley assembly comprises a support having a driven pulley mounted thereon for rotation about a first axis and a pivot point for pivoting around a second axis normal to the first axis, with a drive belt passing around the drive and driven pulleys in a substantially planar belt run, the support being pivotable about the second axis relative to the engine allowing the driven pulley to be tilted relative to the plane of the belt run to enable the drive belt to be located on the driven pulley without stretching the belt.

9. The engine as claimed in claim 8, wherein the support has a cavity therein in use for receiving a lever for tensioning the drive belt.

10. The engine as claimed in claim 8, wherein the support is provided with a lug which in use is engagable with a detent to locate the driven pulley for correct tensioning of the drive belt.

11. The engine as claimed in claim 8, wherein the support is pivoted to the engine at a point offset behind the rotational plane of the driven pulley.

12. The engine as claimed claim 8, wherein the pivot point is provided by a through bore in the support which in use co-operates with a bolt to form a pivot.

13. The engine as claimed in claim 12, wherein the bore is tapered to allow the support to rock relative to the bolt when not tightly clamped.

14. The engine as claimed in claim 13, wherein the support is mounted on the engine by a plurality of bolts, one of which acts as the pivot for the support.

15. The assembly as claimed in claim 8, wherein the pulley assembly is an idler pulley assembly.
